(19) United States
(12) Patent Application Publication
(10) Pub. No.: US 2011/0241950 A1
(43) Pub. Date: Oct. 6, 2011

(54) COMBINATION ANTENNA AND METHODS

(76) Inventors: Zlatoljub Milosavljevic, Espoo (FI); Heikki Korva, Tupos (FI)

(21) Appl. No.: 13/120,412

(22) PCT Filed: Sep. 17, 2009
(86) PCT No.: PCT/FI2009/050744

§ 371 Date: Jun. 20, 2011

(30) Foreign Application Priority Data
Sep. 25, 2008 (FI) 20085907

(51) Int. Cl. H01Q 1/24

(52) U.S. Cl. 343/702

(57) ABSTRACT

An antenna combination especially intended for small radio devices. It comprises a main antenna, the radiator (320) of which is a conductive part of the outer cover of the device, and a second antenna to enable simultaneous operation in the frequency bands close to each other. The second antenna is a narrow ILA, and its radiator (330) is placed in a slot (SLT) between the radiator (320) of the main antenna and the rest (COV) of the cover. The matching circuits of the antennas are implemented so that they function at the same time as filters, which enhance the electric isolation of the antennas. A second antenna can be added to a radio device with a cover radiator so that its radiator does not require extra space, and the electric isolation between the antennas is good despite the closeness of their radiators.

The invention relates to a combination of the antennas isolated electrically from each other. It is especially intended for small-sized mobile terminals for operating in different radio systems.

Since increase in the functions of a mobile terminal, it is usual that an individual device operates at least in two different radio systems. Also in this case one antenna is often enough for the radio device, which antenna has been designed so that its operating bands cover the frequency ranges used by the radio systems in question. Two distinct antennas may be used if a device has to operate, in two systems simultaneously, especially when the frequency ranges used by these systems are relatively close to each other. Such a situation comes into being for example when one system is GSM1800 (Global System for Mobile telecommunications) and the other is GPS (Global Positioning System). Because the transmitting band of GSM1800 is 1710-1785 MHz and the receiving frequency of GPS is 1575 MHz, the receiving of the GPS is susceptible to the interferences caused by the GSM transmittals. A corresponding problem can arise also if a GSM terminal includes, in addition to its basic technique, e.g. Bluetooth or WLAN (Wireless Local Area Network) technique, and particularly if the receiving and transmitting of a same system take place occasionally simultaneously in the terminal. The last-mentioned situation occurs for example in a phone implemented to support the GPRS (General Packet Radio System) category, which requires simultaneous transmitting and receiving.

By means of the separated antennas the interference in the simultaneous receiving caused by the transmitting party can naturally be made smaller than by using a shared antenna. However, the interference does not disappear entirely, because there is a certain electromagnetic coupling between the antennas. This problem can in principle be reduced by increasing the distance between the antennas which, however, is hardly possible for example in a mobile phone. The electromagnetic coupling between the antennas can also be reduced by arranging a grounded strip conductor between them. The flaw of this solution is its difficulty from the point of view of the production and the degradation in the directional characteristics of the antennas.

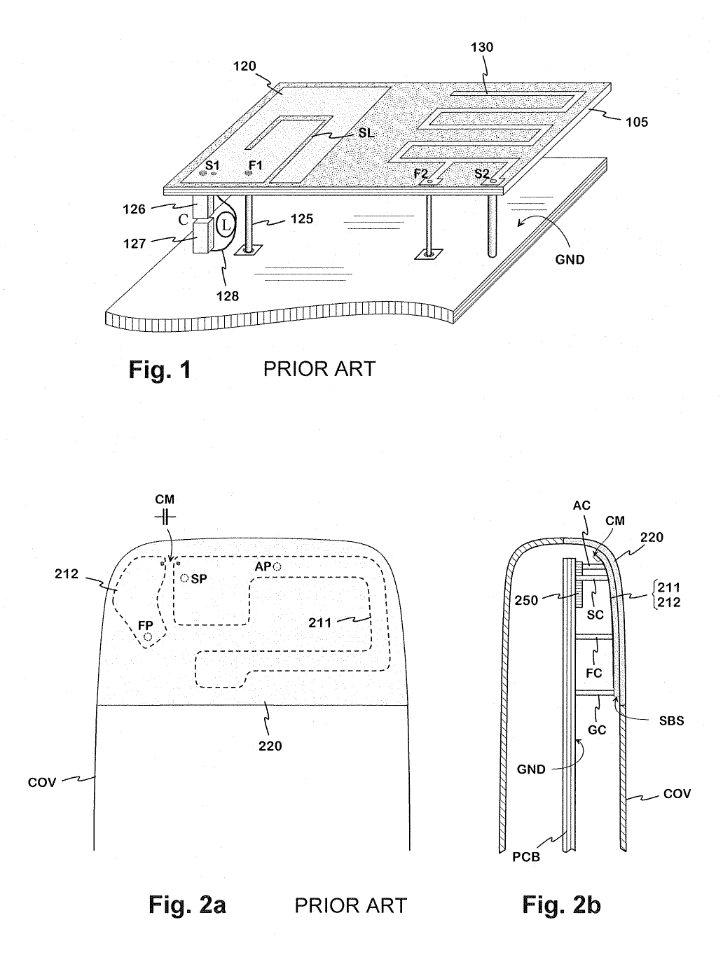

In FIG. 1 there is a solution to the above-described problem, known from the patent publication EP 1315238. The principle is that the interfering antenna includes structural parts which cause a substantial degradation in the radiation characteristics at the frequencies used by the other antenna. In this way the interference level is lowered in the receiver to which the other antenna has been connected. The antenna structure includes two antennas adjacently close to each other. In this case, the radiating/receiving elements of the antennas are conductive patterns on the surface of the circuit board 105, and below them there is the ground plane GND shared between the antennas. The first antenna is a PIFA (Planar Inverted-F Antenna), the element of which, or the radiator 120, is divided by a non-conductive slot SL to two arms of different lengths for constituting two operating bands. The first antenna can be called the main antenna. The second antenna in the example is an IFA, the element 130 of which is here meander-shaped. The first antenna is both a transmitting and receiving one, and the second antenna is at least a receiving one. The feed conductor 125 of the first antenna is connected to the radiator 120 at the first feed point F1 and a short circuit at the first short point S1. The feed conductor of the second antenna is connected to the element 130 at the second feed point F2 and a short conductor at the second short point S2.

The first antenna includes said short circuit instead of a simple short conductor. This circuit consists of a first conductor piece 126 joining to the radiator 120, a second conductor piece 127 joining to the ground plane GND and a conductor wire 128. The first and second conductor piece are next to each other, and their surfaces, which are face to face, are so close to each other that there is a significant capacitance C between them. The conductor wire 128 starts from the ground plane GND and ends after one loop to the radiator 120 beside the joining point of the first conductor piece. The conductor wire 128 has a certain inductance L. The parallel resonance circuit thus constituted is designed so that its resonance frequency equals the medium frequency of the receiving band of the second antenna. In the operating band of the first antenna the impedance of said resonance circuit is low, for which reason the first antenna radiates and receives well. On the other hand, in the operating band of the second antenna the impedance of the resonance circuit is high, in which case the matching of the first antenna is poor and it radiates weakly. Of course the fact that the frequency is aside the transmitting band of the first antenna already degrades the matching, but this alone does not mean a sufficient isolation between the antennas for example in the above-mentioned case of the GSM1800 and GPS.

A disadvantage of the solution according to FIG. 1 is that it is not suitable for the devices, the conductive outer cover of which is used as a radiator corresponding to the element 120 in the first antenna: When the antennas are placed into the space available in a small-sized device, the second antenna degrades the matching of the main antenna in its operating band.

In FIGS. 2a and 2b there is an example of the antenna developed by the applicant, which kind of an antenna together with another antenna forms an antenna combination according to the invention.

A radio device including the antenna is shown in FIG. 2a from behind and in FIG. 2b from the side as a simplified longitudinal section. The antenna comprises a ground plane GND, a radiating element, or radiator 220, its feed element 211 and an adjusting circuit 250. The radiator forms one head of the rear part of the cover COV of the radio device, which head is naturally conductive. The feed element 211 is a conductive strip on the inner surface of a thin and flexible dielectric substrate SBS, the outer surface of which is against the inner surface of the radiator. The feed element is connected from a short-circuit point SP close to its one end to the ground plane by a short-circuit conductor SC seen in FIG. 2b. The feed element extends, starting from the front end, or the end with the short-circuit point, in the transverse direction near to a side edge of the radiator 220, turns there to the longitudinal direction and then back towards the opposite, or second, side edge of the radiator, the tail end being located relatively close to the front end. The transverse direction means here the direction of the head and the longitudinal direction correspondingly the lengthwise direction of the cover COV perpendicular to the transverse direction.

On the inner surface of the substrate SBS there is in this example also a second feed element 212, which is located mostly between the above-mentioned feed element 211 and the second side edge of the radiator. The feed point FP of the antenna is located in the second feed element. The feed point FP is connected to the antenna port of the radio device on its circuit board PCB by the feed conductor FC visible in FIG. 2b.

The second feed element 212 and the front end of the feed element 211 are so close to each other that there is a sufficient electromagnetic coupling between them for transferring transmitting energy to the field of the feed element and further to the field of the radiator 220. On the other hand, the second feed element also feeds electromagnetically directly the radiator. By means of the separate second feed element the chance is enhanced to achieve a good matching simultaneously both in the lower and upper operating band. To this end, the above-mentioned electromagnetic coupling is tuned to be suitable by a capacitor CM, which is connected between the feed elements relatively near to the short-circuit point SP. The upper operating band of the antenna is based on the resonance of the second feed element 212 together with the front end of the feed element 211, the radiator and the ground plane. The lower operating band of the antenna is based on the resonance of the whole feed arrangement together with the other antenna parts.

The antenna according to FIGS. 2a, 2b is adjustable so that its operating bands can be displaced by means of a multiway switch. The switch belongs to an adjusting circuit 250 on the circuit board PCB, which adjusting circuit is connected by a conductor AC to the feed element 211 in the adjusting point AP. In addition, the adjusting circuit includes i.a. reactive circuits, one of which is connected at a time between the adjusting point AP in the feed element and the ground GND.

The object of the invention is to implement in a new and advantageous way an antenna combination, where the antennas are electrically isolated from each other. An antenna combination according to the invention is characterized in that which is specified in the independent claim 1. Some advantageous embodiments of the invention are presented in the dependent claims.

The basic idea of the invention is as follows: A radio device comprises a main antenna, the radiator of which is a conductive part of the outer cover of the device, and a second antenna to enable simultaneous operation in the frequency bands close to each other. The second antenna is a narrow ILA (Inverted-L Antenna), and its radiator is placed in a slot between the radiator of the main antenna and the rest of the cover. The matching circuits of the antennas are implemented so that they function at the same time as filters, which enhance the electric isolation of the antennas.

An advantage of the invention is that a second antenna can be added to a radio device with a cover radiator so that its radiator does not require extra space. This is due to the location of said radiator between the cover parts of the device. A further advantage of the invention is that the electric isolation between the antennas is good despite the closeness of their radiators. This is due to the type and radiator's shape of the second antenna and the filtering characteristics of the matching circuits of the antennas.

The invention is below described in detail. Reference will be made to the accompanying drawings where

FIG. 1 presents an example of the antenna combination according to the prior art,

FIGS. 2a,b present an example of the antenna, in which the radiator is a conductive part of the outer cover of the device,

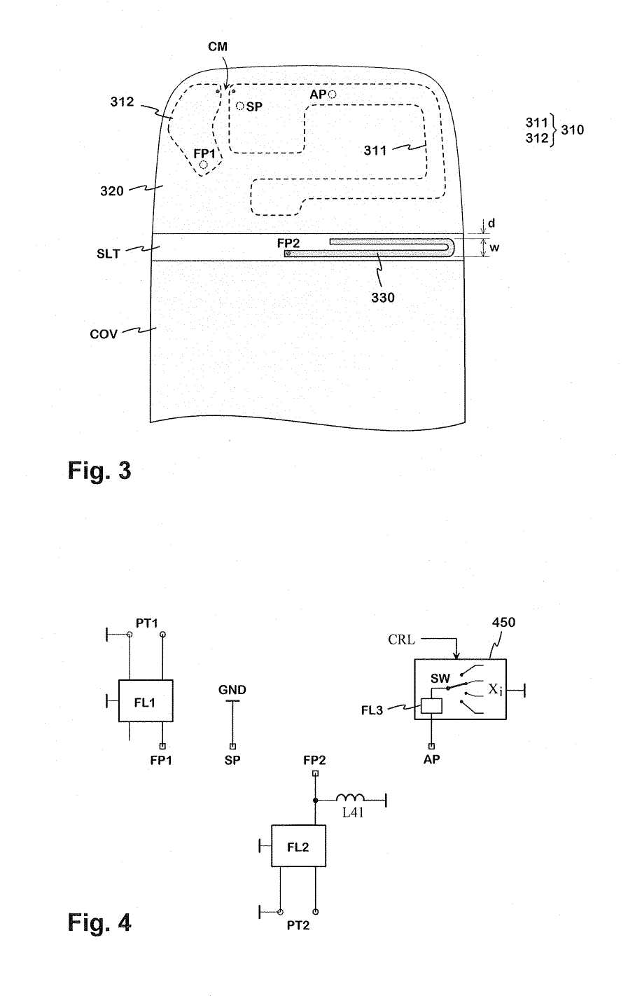

FIG. 3 presents as a device drawing an example of the antenna combination according to the invention,

FIG. 4 presents as a block diagram an example of the filters belonging to the antenna combination according to the invention,

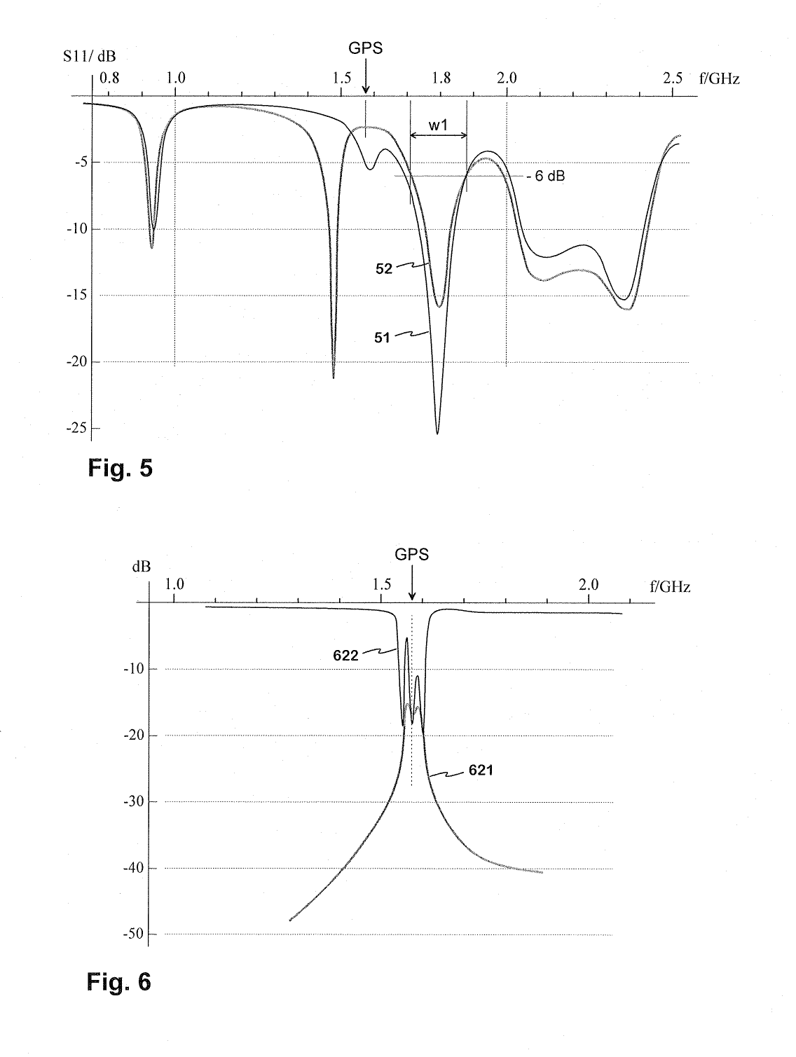

FIG. 5 presents an example of the effect of the adding of the second antenna according to the invention on the matching of the main antenna, and

FIG. 6 presents an example of the isolation between the antennas and of the matching of the second antenna in the antenna combination according to the invention.

FIGS. 1 and 2 were already described in conjunction with the description of the prior art.

FIG. 3 shows an example of the antenna combination according to the invention as a device drawing. There a radio device including the antenna is seen from behind. The antenna combination comprises a main antenna and a second antenna. The main antenna is in its basic structure similar to the antenna presented in FIGS. 2a, b. Thus it comprises a main radiator 320, which is a conductive part of the outer cover of the radio device, the feed elements 311 and 312 of the main radiator and an adjusting circuit (not visible) for displacing the operating bands. The feed elements together form the whole feed element 310. The feed point FP1 of the main antenna is located in the smaller feed element 312, and the short-circuit point SP and adjusting point AP in the larger feed element 311, as in FIG. 2a.

The second antenna is of ILA type. Its radiator, or the second radiator 330, is located according to the invention in a relatively narrow slot SLT between the part of the outer cover 320, which functions as the radiator of the main antenna, and the adjacent part COV of the outer cover. The cover part COV is typically located at the battery of the device. Also it can be conductive, in which case it is connected to the ground. The feed point FP2 of the second antenna is located at the end of the second radiator 330 about in the middle of the longitudinal line of the slot SLT. The second radiator starts from the feed point FP2 in the direction of the slot towards the side edge of the device, makes a U-shaped turn close to the side edge and continues some distance back towards the starting end. In practice, there is a ground plane below the second radiator on the circuit board of the device. However, the above-mentioned U-shaped turn is arranged, viewed from above, outside the edge of the ground plane. In the example the tail portion of the second radiator is located close to the edge of the slot SLT on the side of the main radiator 320, and correspondingly the first portion starting from the feed point is located close to the edge of the slot SLT on the side of the cover part COV. Because the slot is narrow, the width w of the second radiator and the distance d between the second radiator and main radiator are small. The width w is at the most 3 mm and the distance d at the most 2 mm.

The second antenna can be used only as a receiving antenna. However, also in that case its element is called ‘radiator’ and the point, from which the element is connected to the receiver, ‘feed point’, for the sake of consistency.

FIG. 4 shows as a block diagram an example of the filters belonging to the antenna combination according to the invention. The feed point FP1, which is located in the feed element of the main antenna, the short-circuit point SP of the feed element, the adjusting point AP and the feed point FP2, which is located in the radiator of the second antenna, are marked in the drawing. Between the antenna port PT1 of the transmitter feeding the main antenna and the feed point FP1 of the main antenna there is a first filter FL1, which belongs to the matching circuit of the main antenna, or the first matching circuit. The aim of the first filter is to enhance the isolation between the antennas at the frequencies of the operating band of the second antenna. The first filter FL1 includes e.g. a capacitor and a coil in series between the feed conductor and ground GND, which components together with the antenna impedance constitute a band-stop filter, the stop band of which falls into the operating band of the second antenna. In this case the frequency components of the transmitting signal of the transmitter, which feeds the main antenna, in the operating band of the second antenna, already weak in itself, can not propagate as far as the radiator and thus interfere the signals in the second antenna. Such a filter based on a transverse serial resonance filter hardly causes extra attenuation in the transmitting band of the main antenna and thus increase in the losses of the transmitter.

Between the antenna port PT2 of the transmitter and/or receiver, which uses the second antenna, and the second feed point FP2 there is a second filter FL2, which belongs to the matching circuit of the second antenna, or the second matching circuit. The aim of the second filter is to enhance the isolation between the antennas at least in the operating band of the main antenna, which is located next to the operating band of the second antenna. The impedance of the second filter at the frequencies of the operating band of the main antenna is arranged to be very high, for which reason the second antenna does not degrade the operation of the main antenna. This is achieved, when the second filter is e.g. a band-pass filter, the pass band of which covers the operating band of the second antenna. In fact the second filter FL2 then improves the matching of the main antenna. In this example the second matching circuit comprises also a coil L41 connected between the second feed point and the ground.

In FIG. 4 there is also seen as a block an adjusting circuit 450 connected to the adjusting point AP in the feed element of the main antenna. In the adjusting circuit there is a multi-way switch SW and reactances Xᵢ, one of which is at a time connected between the adjusting point AP and the ground GND, the number of which corresponds to the number of the switch states. The switch state is set by the control signal CRL. The adjusting circuit of a dual-band main antenna can be designed for example so that when the switch state is changed from a certain state to another certain state, the impedance of the adjusting circuit changes from low to high in the dower operating band and from high to low in the upper operating band. This again results in that the lower operating band is displaced downwards and the upper operating band upwards or vice versa. The adjusting circuit further includes a third filter FL3, the aim of which is to reduce the effect of the changes in the switch state on the resonance frequency of the second antenna. The third filter includes e.g., in series with the switch, a parallel circuit of a capacitor and coil. This parallel resonance circuit together with the other impedances in the circuit constitutes a band-stop filter, the stop band of which is arranged at the operating band of the second antenna.

FIG. 5 shows an example of the effect of the adding of the second antenna according to the invention on the matching of the main antenna. Curve 51 shows the fluctuation of the reflection coefficient S11 of an antenna like the one in FIG. 2 as a function of frequency, when the switch in the adjusting circuit is in a certain state. The antenna has been designed so that its lowest operating band covers in this case the frequency range of 890-960 MHz of the GSM900 system, and an upper operating band covers the frequency range of 1710-1880 MHz of the GSM1800 system, which range is marked by symbol w1 in the figure. In addition, the antenna has a wide operating band beyond the frequency 2 GHz. Curve 52 shows the fluctuation of the reflection coefficient S11 of an antenna combination like the one in FIGS. 3 and 4 as a function of frequency. The second antenna added to the radio device is intended for the GPS receiving. The inductance of the coil in the serial resonance circuit being located in the filter FL1, which belongs to the matching circuit of the main antenna, is 34 nH, and the capacitance of the capacitor is 0.3 pF. The filter FL2, which belongs to the matching circuit of the second antenna, is in this case a band-pass filter of SAW type (Surface Acoustic Wave), in pass band of which the GPS frequency 1575.42 MHz is located. The inductance of the matching coil L41 according to FIG. 4 is 3.3 nH. The switch in the adjusting circuit of the main antenna is in the same state as in the case of curve 51.

It is found from FIG. 5 that adding the GPS antenna degrades the function of the main antenna in the upper operating band w1, but only slightly. If the value −6 dB of the reflection coefficient is used as a criterion for the boundary frequencies of a band, the width of the operating band is decreased from the value 185 MHz to value 170 MHz.

It is also seen from FIG. 5 that the main antenna has an extra resonance at about the frequency of 1.5 GHz, which resonance is even quite strong when the device includes also the second antenna. The resonance is caused by the switch in the adjusting circuit, and it is by chance located near to the GPS frequency.

Adding the second antenna affects also the efficiency of the main antenna. In the upper operating band the efficiency in free space degrades a little less than one decibel when the GPS antenna is added, however, being still better than −3 dB. In the lower operating band the efficiency on the contrary gets a little better.

FIG. 6 shows an example of the isolation between the antennas and of the matching of the second antenna in the antenna combination according to the invention. The example concerns the same structure as the matching curve 52 in FIG. 5. Curve 621 shows the isolation of the main and second antenna as a function of frequency. A transmitting test signal is fed to the antenna port PT1 of the main antenna, and a level measurement is done in the antenna port PT2 of the second antenna. It is seen from the curve that the isolating attenuation is at least 15 dB and is naturally at its minimum at the GPS frequency. (When speaking about attenuation, the decibel readings on the vertical scale are positive.)

Curve 622 shows the fluctuation of the reflection coefficient of the second antenna as a function of frequency. At the GPS frequency 1575.42 MHz the reflection coefficient is about −18 dB, which is a very satisfactory value. The bandwidth of the second antenna is about 75 MHz, or 4.7%, which also is a satisfactory value.

The antenna combination according to the invention has been described above. Its structure can in details vary from that presented. For example the shape of the radiator of the second antenna, which radiator is located in the slot between the cover parts of a radio device, the position of the radiator in the slot and the location of the feed point in the radiator can vary. The feed element of the main radiator can be also unitary, and the implementing way of the filters in the matching circuits can vary. The inventive idea can be applied in different ways within the scope defined by the independent claim 1.

1-10. (canceled)

11. A multiband antenna apparatus for use in a radio device configurable to operate in at least a first frequency band and a second frequency band, said antenna apparatus comprising:
a first antenna element having a first dimension and a second dimension and configured to operate in at least the first frequency band, the first antenna element comprising:
a first feed point and a first radiator, the radiator comprising a conductive element disposable at least partially on an exterior cover the radio device; and
a first matching circuit, configured to couple the first feed point to a first antenna port of the radio device; and
a second antenna element configured to operate in the second frequency band, the second antenna element comprising:
a second radiator comprising a third dimension and a fourth dimension; and
a second matching circuit, configured to couple the second radiator to second antenna port of the radio device.

12. The multiband antenna apparatus of claim 11, wherein:
the second radiator is spaced from the first radiator by a non-conductive gap having a width;
the first and the second radiators are configured such that the third dimension is substantially parallel to the first dimension;
the second antenna element is configured as an inverted-L antenna (ILA);
the first matching circuit comprises a first filter having a stop band configured to correspond to the second frequency band; and
the second matching circuit comprises a second filter configured to electrically isolate the second antenna from the first antenna operating in at least the first frequency band.

13. The multiband antenna apparatus of claim 12, wherein the second radiator is spaced from the first radiator along the second dimension.

14. The multiband antenna apparatus of claim 12, wherein the width is selected not to exceed 2 mm.

15. The multiband antenna apparatus of claim 12, wherein the fourth dimension is selected not to exceed 3 mm.

16. The multiband antenna apparatus of claim 15, wherein the second filter is configured to have a first impedance corresponding to the first frequency band and a second impedance, the first impedance being greater than the second impedance.

17. A portable radio device, comprising:
a ground plane;
a first and a second antenna port;
an exterior cover having a first portion and a non-conductive slot disposed adjacent to the first portion, the slot having a first dimension and a second dimension; and
a multiband antenna configurable to operate in at least a first frequency band and a second frequency band, said multiband antenna comprising:
a first antenna element, comprising a first feed point and a first radiator, the first radiator disposed at least partially within the first portion; and
a first matching circuit, configured to couple the first feed point to the first antenna port; and
a second antenna element, comprising a second radiator; and
a second matching circuit configured to couple the second radiator to the second antenna port.

18. The portable radio device of claim 17, wherein:
the second radiator comprises a third dimension and a fourth dimension;
the second radiator is disposed substantially within the slot such that the third dimension is substantially parallel with the first dimension; and
the second radiator is spaced from the first radiator by a predetermined first distance.

19. The portable radio device of claim 17, wherein the second antenna element comprises an inverted-L antenna (ILA).

20. The portable radio device of claim 17, wherein the first matching circuit comprises a first filter having a stop band corresponding to the second frequency band.

21. The portable radio device of claim 20, wherein the second matching circuit comprises a second filter configured to electrically isolate the second antenna from the first antenna operating in at least the first frequency band.

22. The portable radio device of claim 17, wherein the second radiator comprises:
a first substantially linear portion having the second feed point disposed thereon and arranged substantially parallel to a third dimension of the second radiator;
a second substantially linear portion arranged substantially parallel with the first portion; and
a ‘U’-shaped portion disposed proximate an edge of the non-conductive slot, the edge distant from the second feed point, the U-shaped portion configured to couple the second portion to the first portion thereby forming a contiguous structure.

23. The portable radio device of claim 22, wherein a normal projection of the U-shaped portion is configured substantially external to a normal projection of the ground plane.

24. The portable radio device of claim 17, wherein the first filter comprises a band-stop filter comprising a serial resonance circuit coupled between the first feed point and the ground plane.

25. The portable radio device of claim 24, wherein the second filter comprises a band-pass filter having a pass band corresponding to the second frequency band.

26. The portable radio device of claim 25, wherein the second filter further comprises a surface acoustic wave filter.

27. The portable radio device of claim 17, wherein the second matching circuit comprises an inductor coupled between the second feed point and the ground plane.

28. The portable radio device of claim 17, wherein the first antenna element further comprises an adjusting circuit coupled to the first radiator and configured to effect a predetermined frequency shift in at least one of the first and the second operating frequency bands, the adjusting circuit comprising:
a switch; and
at least two reactive circuits, each coupled to the ground plane and each being selectable by the switch.

29. A multiband antenna apparatus for use in a radio device capable of operating in at least a first frequency band and a second frequency band, the device comprising an exterior cover having a first portion and a non-conductive slot disposed adjacent to the first portion, the slot having a first dimension and a second dimension; said multiband antenna comprising:
a first antenna element, comprising a first feed point and a first radiator, the first radiator disposed at least partially within the first portion; and
a first matching circuit, configured to couple the first feed point to a first antenna port of the portable radio device; and
a second antenna element, comprising:
a second radiator having a third dimension and a fourth dimension; and
a second matching circuit, configured to couple the second radiator to a second antenna port; wherein:
the second radiator disposed substantially within the slot such that the third dimension is substantially parallel with the first dimension; and
the second radiator is spaced from the first radiator by a first distance.

30. The antenna apparatus of claim 29, wherein the second antenna element comprises an inverted-L antenna (ILA).

31. The antenna apparatus of claim 29, wherein:
the first matching circuit comprises a first filter having a stop band corresponding to the second frequency band; and
the second matching circuit comprises a second filter configured to electrically isolate the second antenna element from the first antenna element operating in at least the first frequency band.

32. The antenna apparatus claim 29, wherein the second radiator comprises:
a first substantially linear portion having the second feed point disposed thereon and arranged substantially parallel to the third dimension;
a second substantially linear portion arranged substantially parallel with the first portion; and
a substantially arcuate portion disposed proximate an edge of the slot, the edge distant from the second feed point, the arcuate portion configured to couple the second portion to the first portion thereby forming a contiguous structure.

33. The antenna apparatus of claim 32, wherein a normal projection of the substantially arcuate portion is disposed external to a normal projection of a ground plane of the portable radio device.

34. The antenna apparatus of claim 29, wherein:
the first filter comprises a band-stop filter comprising a serial resonance circuit coupled between the first feed point and the ground plane; and
the second filter comprises a band-pass filter having a pass band which includes the second frequency band.

35. The antenna apparatus claim 29, wherein the first antenna element further comprises an adjusting circuit coupled to the first radiator and configured to effect a frequency shift in at least one of the first and the second operating frequency bands, the adjusting circuit comprising a third filter configured to maintain a resonance frequency of the second antenna element in response to a state change of a switch of the adjusting circuit.

36. The antenna apparatus claim 35, wherein in the third filter comprises a capacitive and an inductive element effecting a parallel circuit, the parallel circuit configured in series with the switch thereby effecting a band-stop filter, the band-stop filter having a second stop-band configured to include the second frequency band.

37. An antenna combination of a radio device comprising a ground plane, or ground (GND), and a main antenna and second antenna to enable a simultaneous operation in frequency bands close to each other, main antenna comprising:
a main radiator being a conductive part of an outer cover of the radio device, a feed element, which has only an electromagnetic coupling to the main radiator, and
a first matching circuit between a first antenna port of the radio device and the feed element, and
wherein the second antenna comprises a second radiator; and
a second matching circuit between a second antenna port of the radio device and the second radiator, characterized in that the second antenna comprises an inverted-L antenna (ILA), and the second radiator is located in a slot between the main radiator and a rest of the outer cover of the radio device so that the longitudinal direction of the second radiator is the direction of an edge of the main radiator next to the second radiator, the distance between the main radiator and the second radiator being at most 2 mm, and the width of the second radiator being at the most 3 mm; and
wherein:
the first matching circuit comprises a first filter, the stop band of which covers an operating band of the second antenna, and
the second matching circuit comprises a second filter, the impedance of which is selected so that in at least one operating band of the main antenna, a desired level of the electric isolation between the antennas is achieved.

38. An antenna combination according to claim 37, characterized in that the second radiator starts from its feed point in the direction of said slot towards a side edge of the radio device, makes a U-shaped turn and continues a distance back towards the starting end.

39. An antenna combination according to claim 38, characterized in that said U-shaped turn is located, viewed in the direction of the normal of the outer cover, outside the edge of the ground plane.

40. An antenna combination according to claim 37, characterized in that the main antenna further comprises an adjusting circuit connected between its feed element and the ground (GND), which circuit comprises a multi-way switch and at least two alternative reactances (Xᵢ) to displace at least one operating band of the main antenna.

41. An antenna combination according to claim 40, characterized in that the adjusting circuit further comprises a third filter to reduce the effect of the changes in the switch state on the resonance frequency of the second antenna.
